(19) United States
(12) Patent Application Publication
(10) Pub. No.: US 2005/0108051 A1
(43) Pub. Date: May 19, 2005

(54) Method of promoting patient adherence to a treatment regimen

(76) Inventor: Andrew Weinstein, Newark, DE (US)

Correspondence Address: CONNOLLY BOVE LODGE & HUTZ LLP, SUITE 800, 1990 M STREET NW, WASHINGTON, DC, 20036-3425, US

(21) Appl. No.: 10/968,149

(22) Filed: Oct. 20, 2004

Related U.S. Application Data
(60) Provisional application No. 60/517,877, filed on Nov. 7, 2003.

(51) Int. Cl. G06F 17/60

(52) U.S. Cl. 705/2

(57) ABSTRACT

A method and apparatus for promoting and improving patient adherence to a treatment regimen for a chronic disease. The method including the steps of surveying a patient with questions related to the treatment of the chronic disease; analyzing the patient's survey responses to said questions; selecting instructions for healthcare providers and patients based on analyzing the patient's survey responses; communicating the patient's survey responses and instructions for healthcare providers to the healthcare providers; communicating instructions for the patient to the patient; and prescribing a new treatment regimen to improve the patient's adherence based on the patient's survey responses and instructions communicated to the healthcare providers and the patient.

### FIELD OF THE INVENTION

The present invention is a method and apparatus for promoting and monitoring a patient's adherence to a treatment regimen.

### BACKGROUND OF THE INVENTION

An intrinsic problem in modern medicine is patient adherence to a prescriptive or other plan for treatment of chronic illnesses and diseases such as asthma, diabetes, arthritis, gastrointestinal disorders, and the like. The present invention is a multi-faceted apparatus and method for aiding healthcare providers in encouraging patient adherence to a treatment plan for his or her chronic illness.

U.S. Pat. No. 4,803,625 discloses one background art approach for encouraging patient adherence to a medical treatment regimen. In particular, the '625 patent discloses a “personal health monitor” that is programmed to remind patients to take medications at prescribed times via a timed alarm (See FIG. 13 and column 14, lines 15-41). The patient's response to the alarm is monitored at a medical facility. This method relies upon an alarm ringing in the patient's home and is likely to be disabled or disconnected by patients who get fed up with the alarms. Therefore, this method may lose its value as a means to promote a patient's adherence to a treatment regimen.

U.S. Pat. No. 5,016,172 discloses a patient compliance system that utilizes a monitor attached to a patient's medicine container. In particular, the '172 patent discloses an approach where the monitor registers how often the medicine container is opened and reports that data to a healthcare provider, relative or other monitoring entity (See FIG. 1 and column 2, lines 45-58). Any overdose or missed dosage is then reported to the patient by the monitoring entity (column 4, lines 13-18).

U.S. Pat. Nos. 5,200,891; 5,642,731; and 6,085,752 generally describe portable electronic devices with visual displays that remind patients to take their medications. In particular, the '752 patent describes a device that not only stores and dispenses medicine but also enables distant monitoring of medicine used by the patient. In addition, the electronic device of the '752 patent may be programmed to provide positive reinforcement to the patient (See FIGS. 6-9 and column 3, line 50 to column 4, line 9). Moreover, alarms are also included with the device of the '752 patent to promote adherence to a treatment regimen of prescribed medications for a patient (See column 8, lines 13-24; and column 9, lines 46-55).

U.S. Pat. No. 6,356,873 attempts to approach patient adherence to a treatment regimen from the standpoint of pre-selecting and screening patients to determine their suitability for a particular medication and/or health care therapy. Once selected, the '873 patent discloses that the patient is instructed via computer on the optimal use of the medication (See column 7, line 65 to column 8, line 59). In addition, U.S. Pat. No. 6,014,631 discloses a similar approach to that of the '873 patent.

U.S. Pat. No. 6,514,200 discloses a patient monitoring device that includes a microprocessor, memory and physical sensors worn by the patient. In particular, the sensors provide an electrical signal that can be used to confirm the patient adherence with a treatment regimen.

U.S. Pat. No. 6,723,045 discloses a patient monitoring apparatus that includes a microprocessor, memory and input devices provided for the patient to enter data. In particular, the patient uses an input device to communicate information such as wellness parameters to the patient monitoring apparatus.

The World Health Organization published a report in 2003 entitled “Adherence to Long-Term Therapies; Evidence for Action” that includes sections authored by the inventor of this application and others. This report provides further background information on patient adherence and factors affecting patient non-adherence.

The background art approaches discussed above encourage adherence to medical treatment regimens. However, these background art approaches ignore an essential element in maintaining patient adherence, namely, the patient's inputs to the healthcare provider. More specifically, they ignore the fact that multiple factors influence a patient's adherence with a prescribed regimen ranging from personal to financial. An improved understanding of the patient's attitudes and thinking can lead to greater patient adherence to a prescribed treatment regimen.

Therefore, there is a need in the art for tools that would allow healthcare providers: (1) to better understand what a patient is thinking and doing in regards to his/her treatment regimen and (2) to react in response to these patient inputs to prevent or reverse non-adherence with the prescribed treatment regimen.

### SUMMARY OF THE INVENTION

The present invention provides an apparatus and method for interrogating a patient about the multiple factors that affect the patient's understanding of his/her chronic disease or condition and that impact the patient's adherence to a treatment regimen for the chronic disease. The responses from the patient interrogation survey provide guidance to a healthcare provider regarding a specific patient's attitudes and health concerns and how to prevent or correct patient non-adherence with a prescribed treatment regimen. The patient interrogation survey is facilitated by using hardware and software of an interactive computer and communication system. The computer and communication system comprises at least a central processing unit (CPU), display devices, input/output devices, memory and a suitable operating system.

One embodiment of the present invention is a method for promoting and improving patient adherence to a treatment regimen for a chronic disease comprising: surveying a patient with questions based on a group of factors related to the treatment of the chronic disease; analyzing the patient's survey responses to said questions; selecting instructions for healthcare providers based on analyzing the patient's survey responses; selecting instructions for the patient based on analyzing the patient's survey responses; communicating the patient's survey responses and instructions for healthcare providers to the healthcare providers; communicating instructions for the patient to the patient; and prescribing a new treatment regimen to improve the patient's adherence based on the patient's survey responses and instructions communicated to the healthcare providers and the patient.

In the embodiment of the invention discussed above, preferably said group of factors further comprises at least one of the patient's attitude toward the condition being treated, the patient's understanding of the treatment prescribed, the patient's self-assessment of his/her adherence to the treatment regimen, the patient's satisfaction with the healthcare provider, the patient's understanding of factors affecting the chronic disease being treated; and the patient's concerns about the treatment regimen. Moreover, said patient's concerns include at least one of cost, side effects and the patient's support structure.

In the embodiment of the invention discussed above, preferably said analyzing is performed by at least one of a computer system local to the patient and a computer system local to the healthcare provider. In addition, preferably said selecting instructions for healthcare providers is performed by at least one of a computer system local to the patient and a computer system local to the healthcare provider. Moreover, preferably said selecting instructions for the patient is performed by at least one of a computer system local to the patient and a computer system local to the healthcare provider.

In the embodiment of the invention discussed above, preferably said communicating the patient's responses and instructions is provided by at least one of direct communications, wireless communications, local area networks and Internet. In addition, preferably said communicating instructions for the patient is provided by at least one of direct communications, wireless communications, local area networks and Internet. Further, preferably said direct communications includes at least one of oral, written and wired telephone communications. Moreover, preferably said wireless communications includes at least one of radio and cellular telephone.

Another embodiment of the present invention is an apparatus for promoting and improving patient adherence to a treatment regimen for a chronic disease comprising: means for surveying the patient with questions based on a group of factors related to the treatment of the chronic disease; means for analyzing the patient's survey responses to said questions; means for selecting instructions for healthcare providers based on analyzing the patient's survey responses; means for selecting instructions for the patient based on analyzing the patient's survey responses; means for communicating the patient's responses and instructions for healthcare providers to the healthcare providers; means for communicating the instructions for the patient to the patient; and means for prescribing a new treatment regimen to improve the patient's adherence based on the patient's survey responses and instructions communicated to the healthcare providers, wherein the means for surveying and the means for analyzing are connected by the means for communicating.

In the embodiment of the invention discussed above, preferably said group of factors comprise at least one of the patient's attitude toward the condition being treated, the patient's understanding of the treatment regimen prescribed, the patient's self-assessment of his/her adherence to the treatment regimen, the patient's satisfaction with the healthcare provider, the patient's understanding of factors affecting the chronic disease being treated; and the patient's concerns about the treatment regimen. In addition, preferably said patient's concerns include at least one of cost, side effects and the patient's support structure.

In addition, in the embodiment of the invention discussed above, preferably said means for analyzing includes at least one of a computer and communication system local to the patient and a computer and communication system local to the healthcare provider. Further, preferably said means for selecting is performed by at least one of a computer system local to the patient and a computer system local to the healthcare provider. Furthermore, said means for analyzing further comprises a microprocessor, memory, input devices and output devices. Moreover, preferably said memory is at least one of a diskette, compact flash and portable media; said input devices are at least one of a touch panel screen display, keyboard, mouse and microphone; and said output devices are at least one of a graphics display monitor and speaker.

Further, in the embodiment of the invention discussed above, preferably said means for communicating is provided by at least one of direct communications, wireless communications, local area networks and Internet.

### BRIEF DESCRIPTIONS OF DRAWINGS

The invention will be better understood by reference to the Detailed Description of the Invention when taken together with the accompanying drawings, wherein:

FIG. 1 shows an exemplary embodiment of a computer and communication system for implementation of the present invention;

FIG. 2 shows an exemplary flow diagram of the method of the invention;

FIG. 3 shows an exemplary display of an overview of patient interrogation survey responses;

FIG. 4A shows an exemplary set of survey responses regarding a patient's attitude/behaviors toward the chronic disease being treated;

FIG. 4B shows an exemplary set of instructions for a healthcare provider based on the survey responses regarding a patient's attitude/behavior toward the chronic disease being treated;

FIG. 4C shows an exemplary set of instructions for a patient based on the survey responses regarding a patient's attitude/behavior toward the chronic disease being treated;

FIG. 5A shows an exemplary set of survey responses regarding allergen/irritants affecting the chronic disease being treated;

FIG. 5B shows an exemplary set of instructions for a healthcare provider based on the survey responses regarding allergen/irritants affecting the chronic disease being treated;

FIG. 5C shows an exemplary set of instructions for a patient based on the survey responses regarding allergen/irritants affecting the chronic disease being treated;

FIG. 6A shows an exemplary set of survey responses regarding medical factors affecting the chronic disease being treated;

FIG. 6B shows an exemplary set of instructions for a healthcare provider based on the survey responses regarding medical factors affecting the chronic disease being treated;

FIG. 6C shows an exemplary set of instructions for a patient based on the survey responses regarding medical factors affecting the chronic disease being treated;

FIG. 7A shows an exemplary set of survey responses regarding psychological factors affecting the chronic disease being treated;

FIG. 7B shows an exemplary set of instructions for a healthcare provider based on the survey responses regarding psychological factors affecting the chronic disease being treated;

FIG. 7C shows an exemplary set of instructions for a patient based on the survey responses regarding psychological factors affecting the chronic disease being treated;

FIG. 8A shows an exemplary set of survey responses regarding a patient's concerns about medication that is part of a treatment regimen for the chronic disease;

FIG. 8B shows an exemplary set of instructions for a healthcare provider based on the survey responses regarding a patient's concerns about medication that is part of a treatment regimen for the chronic disease;

FIG. 8C shows an exemplary set of instructions for a patient based on the survey responses regarding a patient's concerns about medication that is part of a treatment regimen for the chronic disease;

FIG. 9A shows an exemplary set of survey responses regarding a patient's medication preferences with respect to a treatment regimen for the chronic disease;

FIG. 9B shows an exemplary set of instructions for a healthcare provider based on the survey responses regarding a patient's medication preferences with respect to a treatment regimen for the chronic disease;

FIG. 9C shows an exemplary set of instructions for a patient based on the survey responses regarding a patient's medication preferences with respect to a treatment regimen for the chronic disease;

FIG. 10A shows an exemplary set of survey responses regarding a patient's comprehension/understanding of medications/equipment that is a part of a treatment regimen for the chronic disease;

FIG. 10B shows an exemplary set of instructions for a healthcare provider based on the survey responses regarding a patient's comprehension/understanding of medications/equipment that is a part of a treatment regimen for the chronic disease;

FIG. 10C shows an exemplary set of instructions for a patient based on the survey responses regarding a patient's comprehension/understanding of medications/equipment that is a part of a treatment regimen for the chronic disease;

FIG. 11A shows an exemplary set of survey responses regarding cost of care for a treatment regimen for the chronic disease;

FIG. 11B shows an exemplary set of instructions for a healthcare provider based on the survey responses regarding cost of care for a treatment regimen for the chronic disease;

FIG. 11C shows an exemplary set of instructions for a patient based on the survey responses regarding cost of care for a treatment regimen for the chronic disease;

FIG. 12A shows an exemplary set of survey responses regarding patient's satisfaction with healthcare providers;

FIG. 12B shows an exemplary set of instructions for a healthcare provider based on the survey responses regarding patient satisfaction with healthcare providers;

FIG. 12C shows an exemplary set of instructions for a patient based on the survey responses regarding patient satisfaction with healthcare providers;

FIG. 13A shows an exemplary set of survey responses regarding patient's quality of life;

FIG. 13B shows an exemplary set of instructions for a healthcare provider based on the survey responses regarding patient's quality of life;

FIG. 13C shows an exemplary set of instructions for a patient based on the survey responses regarding patient's quality of life;

FIG. 14A shows an exemplary set of survey responses regarding support for a patient with a chronic disease;

FIG. 14B shows an exemplary set of instructions for a healthcare provider based on the survey responses regarding support for a patient with a chronic disease; and

FIG. 14C shows an exemplary set of instructions for a patient based on the survey responses regarding support for a patient with a chronic disease.

### DETAILED DESCRIPTION OF THE INVENTION

The present invention has been designed to assist healthcare providers in developing a treatment regimen that is individually tailored for each patient with a chronic disease and to promote patient adherence to the treatment regimen. Treatment of most chronic diseases requires daily medication. Improving patient adherence to this type of treatment regimen is facilitated by the present invention. As a non-limiting example, the detailed description of the invention will focus on the treatment of one chronic disease, namely, asthma. However, it is to be understood that the invention is applicable to the treatment of other chronic diseases as well.

The treatment of asthma has been selected as an exemplary illustration of the invention because of the complex treatment parameters associated with the disease. More specifically, multiple factors, environmental, medical and psychological, contribute to asthma. This complicates asthma management strategies ranging from symptom management, environmental control and preventative maintenance. Also, effective asthma treatment requires regular patient self-monitoring and understanding of the treatment regimen. Thus, use of asthma as the illustrative embodiment of the invention provides a more complete example of how the invention can be used by a healthcare provider to evaluate a patient's adherence to and understanding of his/her treatment regimen.

The apparatus and method of the present invention comprise an interrogation survey of the patient that focuses on several factors that have a bearing on patient adherence to a treatment regimen. These factors include but are not limited to:
1. the patient's attitude toward the condition being or to be treated, for example, admission that he/she has a chronic condition and its seriousness, as viewed from the patient's perspective;
2. the patient's understanding of the treatment prescribed, for example, whether they really understand when, and how, to take medicine or undergo treatment;
3. the patient's self-assessment of his/her adherence to the treatment regimen, for example an unaided inquiry as to when treatment is self-administered or medication is taken;
4. the patient's satisfaction, confidence or belief in provider, for example, whether the patient actually believes the provider's statements regarding the need for the treatment prescribed, and if not, how that affects adherence;
5. the patient's understanding of factors affecting the condition being treated, from environmental (e.g., the role of allergens, air pollution, etc.) to personal (e.g., infection, reactions to medication, gastroesophageal reflux disease, anxiety, depression etc.) that may exacerbate a chronic disease;
6. the patient's concerns about the treatment prescribed ranging from at least cost of care to medicine side effects; and
7. the patient's family, friends and co-workers as a support structure to reinforce and encourage adherence.

Each step of the patient interrogation survey gives the patient an opportunity to provide a variable response rather than just an absolute “yes” or “no” answer. Such a survey could use a Lickert scale to capture the variable response. A Lickert scale is a rating scale that measures the strength of a respondent's agreement (e.g., strongly agree, agree, undecided, disagree, and strongly disagree) with a set of clear statements (e.g., “I believe I have asthma.”). This type of survey response is used to gauge a respondent's attitudes or reaction to the statement. As a non-limiting example, the survey described above could allow the patient to select a response to a question/statement that indicates their degree of adherence with the variable being analyzed and the opportunity to type in comments that further elaborate on their response to the question/statement.

Each survey response or group of survey responses given by the patient has corresponding instructions for the healthcare provider and the patient that provide guidance with respect to the treatment of the patient for the chronic disease. The specific instructions for each survey response or group of survey responses are contained in a database. The method of the present invention utilizes a computer program to provide appropriate instructions to both the health care provider and the patient that are indicated by a link between the instructions and the survey responses. The link between the survey responses and the instructions is predetermined by the standard practices that a physician or healthcare provider typically applies in diagnosing and treating the patient's chronic disease. In addition, the instructions often include suggestions for how to encourage patient adherence to a treatment regimen that will promote control of the chronic condition. The apparatus and method of the present invention links the patient's survey responses to specific instructions for the healthcare provider and the patient on how to proceed with a treatment regimen for the patient in a manner that will help to promote patient adherence or overcome prior non-adherence to a treatment regimen.

Successful treatment of chronic diseases includes the treatment of the whole patient and his/her surroundings. The apparatus and method of the present invention provides comprehensive patient questioning covering all facets of chronic diseases and provides treatment instructions related to patient's responses to direct healthcare providers. The comprehensive nature of the patient questioning in the present invention provides an apparatus and method for determining the correct treatment regimen for the patient.

The present invention facilitates improved communication between the patient and healthcare providers by using an interactive computer and communication system that contains hardware and software that pose multiple questions to the patient. The computer and communication system is described in more detail below.

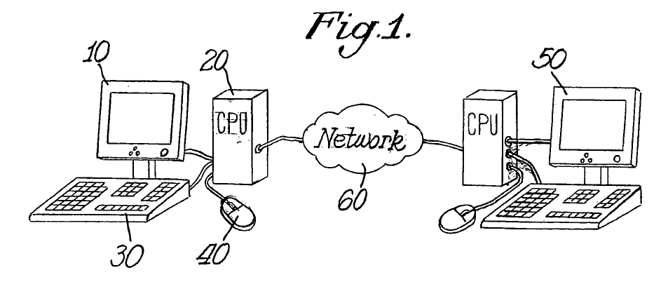

In a non-limiting example, FIG. 1 shows an embodiment of the invention where questions can be posed or outputted to the patient via a monitor 10, speaker or other output device that is connected to a computer 20 through a direct communications connection, wireless communications connection, local area network (LAN) or the Internet. Examples of direct communications include, but are not limited to oral, written and wired telephone communication. Examples of wireless communications include but are not limited to radios and cellular telephones. The patient's survey responses to the questions are inputted by the patient via a keyboard 30 or mouse 40, as shown in FIG. 1.

In addition, other input devices, such as a microphone or touch screen panel, may be used to input the patient's responses. As more fully described below, the patient's survey responses are analyzed in the computer 20 and/or can be transmitted to a computer for analysis. The computer 20 at least includes a microprocessor, memory, input devices and output devices. The computer 20 also includes a monitor 50 or other display/output devices for display that are available to healthcare providers. Further, instructions regarding suggested treatment options are also presented to the healthcare provider on the monitor 50 or other display/output devices.

Alternatively, the patient's responses can be recorded on a diskette, compact flash or other portable media that can be physically transported to healthcare providers for further analysis on the computer and display on the monitor 50 or other display/output device local to the healthcare provider. This interaction between patient and healthcare providers may occur within the confines of the healthcare provider's office or remotely through a communication network 60 such as a LAN, wired or wireless telephone lines, or the Internet, as shown in FIG. 1. Access to the computer and communication system of the present invention by either the patient or healthcare providers can also be provided by using a password in order to insure the privacy and security of the patient and his/her health information.

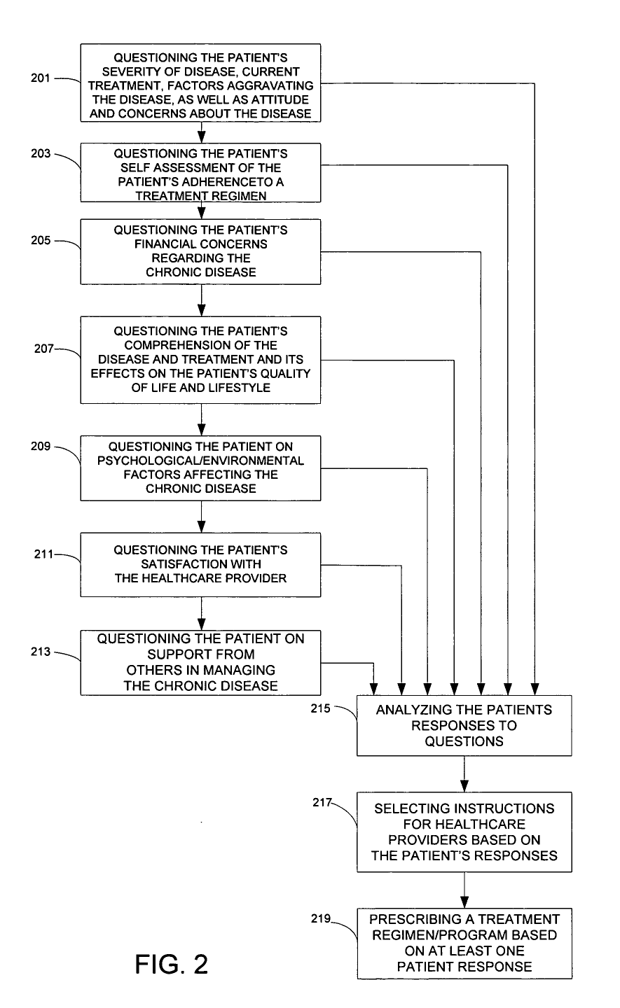

FIG. 2 shows an exemplary flow diagram of the method of the invention. In step 201 of FIG. 2, the patient is questioned regarding his attitude toward the chronic disease for which they are being treated. Step 203 involves questions related to the patient's self-assessment of their adherence to the treatment regimen. The patient is questioned regarding his financial concerns regarding treatment regimen for the chronic disease in step 205 of FIG. 2. In step 207 of FIG. 2, the patient is questioned regarding their understanding and administration of the medicines of the treatment regimen. In addition, the affects of the medicines on the chronic disease and the patient's lifestyle are determined in step 207. Step 209 shows the questioning of the patient regarding psychological/environmental factors affecting the disease. In step 211 of FIG. 2, questions are asked surveying the patient's satisfaction with the healthcare provider. The patient is questioned regarding support from others in managing the chronic disease in step 213. The survey responses from the various interrogation questions are analyzed in step 215 of FIG. 2. In step 217, selection of instructions for the healthcare provider based on the patient's survey responses is performed. Considering the patient's survey responses, instructions and the healthcare provider's judgment as to the veracity of the survey response, the healthcare provider prescribe a new treatment regimen in step 219.

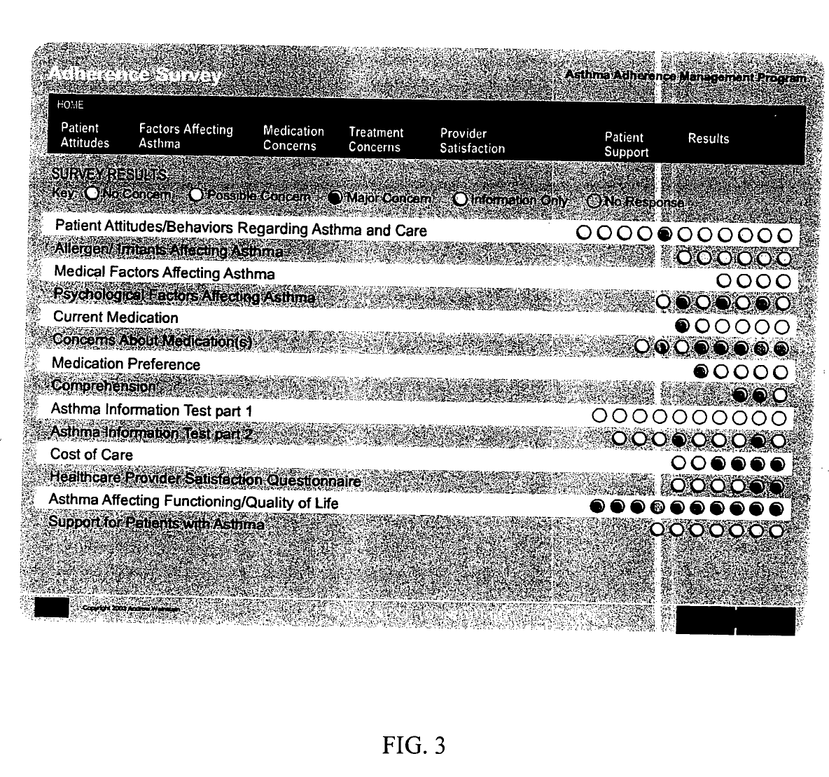

FIG. 3 shows an exemplary display of an overview of some of the factors that would be a part of a patient interrogation survey. A patient's adherence with his/her existing treatment regimen is analyzed by considering a patient's survey responses regarding several of these factors. Examples of these factors include, but are not limited to, those listed across the top of FIG. 3. The factors of FIG. 3 are as follows: (1) the patient's attitude/behaviors regarding the chronic disease being treated; 2) medical factors affecting the chronic disease; (3) the patient's concerns regarding the medication in a current treatment regimen; (4) testing the patient's knowledge of information related to the chronic disease; (5) the patient's concerns about the “cost of care” of treatment regimen prescribed which may range from financial costs to side effects of medicines; and (6) the ways in which the chronic disease may affect the patient's “quality of life.”

In addition, each circle shown in FIG. 3 represents a survey response and an instruction for a healthcare provider that is linked to questions asked under each of the factors listed. As a non-limiting example of how the apparatus and method of the invention link patient survey responses and instructions for healthcare providers, access to the instructions for the healthcare provider can be obtained by selecting the circle shown in FIG. 3 that corresponds to a survey response.

Further, each circle shown in FIG. 3 may be color coded according to the “SURVEY RESULTS key” shown at the top of the figure. Color coding the circles can give the healthcare provider observing this display a visual indication of the degree of importance of a survey response/instruction combination to improving an existing treatment regimen. As a visual indication to the health care provider of the degree of importance of the survey response/instruction combination, the following color code may be used as a non-limiting example of a color code-to-degree of importance SURVEY RESULTS key: green=no concern; yellow=possible concern; red=major concern; blue=information only; clear=no response.

Each of the factors discussed above are carefully probed through survey responses from the patient and linked to corresponding instructions that are communicated to the healthcare provider through the network and display or output devices of the interactive computer and communication system, as shown in FIG. 1. Additional questions can be asked about the patient's adherence and concerns about existing medications, as well as comprehensive information about other factors that can affect the chronic disease and thereby mask the efficacy of the medication. Examples include but are not limited to the patient's economic, environmental and emotional state.

A factor in measuring patient adherence is the patient's self-assessment of his/her adherence to a treatment regimen and avoidance of possible causative factors. Most chronic diseases are manageable if the patient: (1) avoids adverse environmental and psychological conditions and (2) adheres to a prescribed treatment regimen. The present invention provides meaningful information to the healthcare provider by probing the patient about their environmental and psychological conditions and his/her use of the prescribed medications. FIG. 3 shows an exemplary set of questions posed to asthma patients and can generally be summarized as:
a) Do you avoid environmental conditions that exacerbate your disease, for example, avoidance of known allergens?
b) Do you respond appropriately to a worsening of your disease, for example, by immediate use of an inhaler or use of nitroglycerin?
c) Do you faithfully maintain baseline amounts of prescribed medicine, for example blood pressure pills?

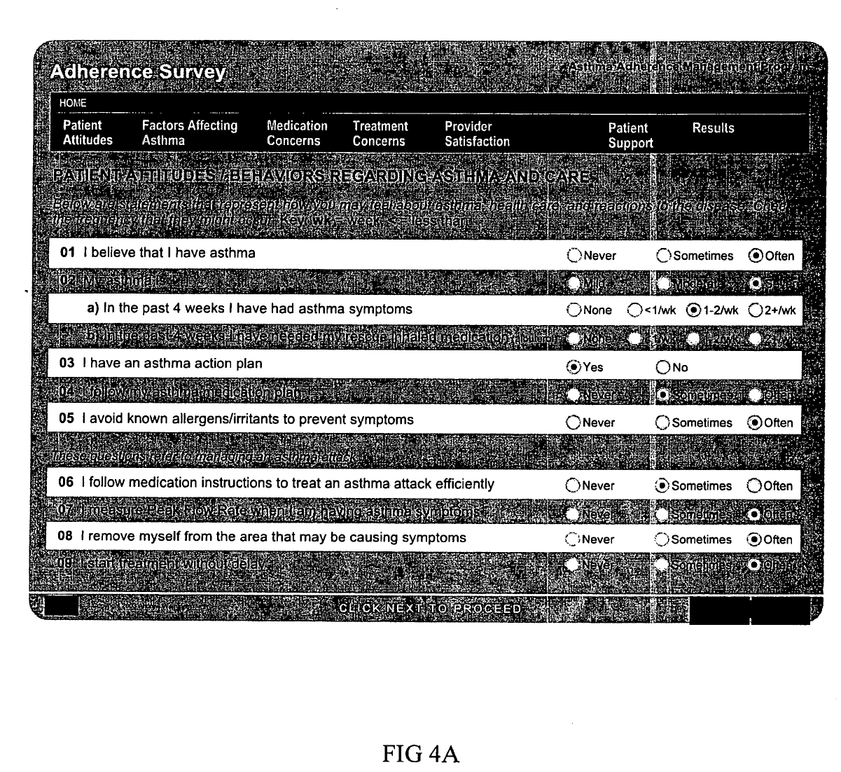

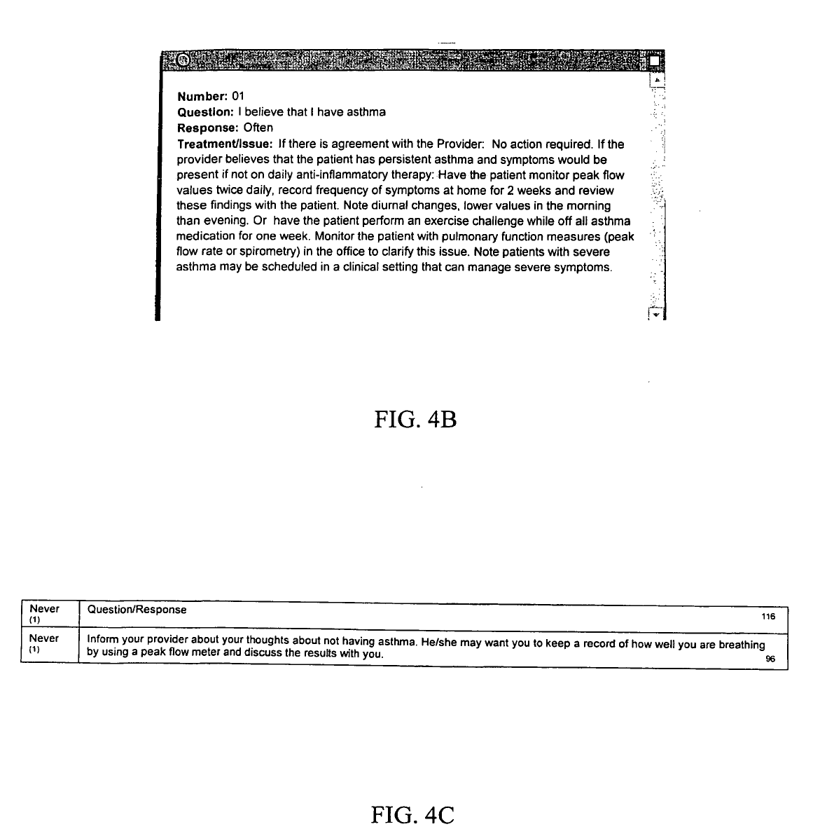

The patient is provided with multiple options for responses that are between the absolute answers of “yes” or “no” to each question, as shown in FIG. 4A. The multiple options for responses provide a rating scale that measures the strength of a patient's agreement (e.g., never, sometimes, often) with a set of clear statements (e.g., “I have an asthma action plan.”). This provides the healthcare provider with a gauge of the patient's adherence to the statement/question being analyzed.

As discussed above, the patient's survey responses to each of the questions prompts a corresponding instruction for the healthcare provider. For example, if the patient admits he/she has not followed the prescribed dosage for medication or his/her answers are inconclusive on the subject, the healthcare provider is instructed to provide detailed instructions to the patient on when and how medication is to be taken. If the patient responses indicate a general reluctance to accept the healthcare provider's instructions on taking the medication, the healthcare provider is instructed to provide the patient with more detailed background, including references, on strategies for encouraging adherence.

FIG. 4A shows an exemplary set of survey responses regarding a patient's attitude/behaviors toward the chronic disease being treated. Each survey response corresponds to one of the circles following the factors, as shown in FIG. 3. FIG. 4B shows an exemplary set of instructions for a healthcare provider based on the survey responses regarding a patient's attitude/behavior toward the chronic disease being treated. FIG. 4C shows an exemplary set of instructions for a patient based on the survey responses regarding a patient's attitude/behavior toward the chronic disease being treated. Each instruction for a healthcare provider and a patient regarding a survey response is accessed by selecting the circle following the factor that corresponds to the survey response.

As described above in the Summary of the Invention, the patient interrogation includes questions regarding the patient's acceptance or recognition of the chronic condition being treated. As shown in the non-limiting example of FIG. 4A, the patient is given a wide spectrum of answering options between the absolute responses of “yes” and “no.” These multiple answering options provide a more accurate indication of the variations in a patient's attitude. However, typically no more than three (3) answer options between the absolute responses (i.e., “yes” or “no”) has been found to be optimal because too many options sometimes cause confusion or lead to lost interest by the patient in an adherence survey program.

As discussed above, each question about the patient's attitude toward the chronic condition shown in FIG. 4A is linked to a set of instructions for the healthcare provider. As shown in FIG. 4B, these instructions for the healthcare provider may range from “no action” (e.g., the instruction linked to a survey response in a case of “no concern,” as indicated in FIG. 3 above) to “possible hospitalization” (e.g., the instruction linked to a survey response in a case of “major concern,” as indicated FIG. 3 above). For example, where the healthcare provider concurs with the patient's self-assessment of his/her chronic disease, the instructions for the healthcare provider may advise that “no action” need be taken. Conversely, if the patient's condition, as seen by the healthcare provider, reflects active asthma and the patient's survey responses reflect denial of the chronic disease or its severity, the instructions for the healthcare provider would counsel active intervention. Examples of active intervention include but are not limited to regular use of an inhaler, daily monitoring of pulmonary function or an exercise challenge that would force the patient to recognize his/her limitations on daily living caused by non-adherence to a prescribed treatment regimen for asthma.

As discussed above, each question posed to a patient has a corresponding group of instructions for the healthcare provider. In particular, these instructions for the healthcare provider are linked to the survey response and displayed on the monitor or other display/output devices observed by the healthcare providers. The healthcare provider is given information by an output device that contains: (1) the patient's survey responses and (2) instructions for the healthcare provider to be used in counseling the patient. For example, as shown in FIG. 4A, if the interrogation question is directed to determining whether the patient believes they have asthma, the survey response is linked to the instructions for the healthcare shown in FIG. 4B. As shown in FIG. 4B, the instructions for the healthcare provider suggest appropriate actions based on: the patient's survey responses to the interrogation questions. In addition, to the instructions, the healthcare providers can assess the accuracy of the patient's survey responses in prescribing a new treatment regimen for the patient.

Another factor in measuring patient adherence to a treatment regimen is alerting patients to how environmental and personal life style choices affect his/her chronic condition. Questions related to this factor are directed to, for example, the potential factors that might trigger or worsen a chronic condition. These patient questions serve the dual functions of: (1) alerting the patient to the likely correlation of such factors to their disease and (2) providing guidelines for instructing healthcare providers on what steps can be taken by the patient to avoid or minimize the effect of such choices.

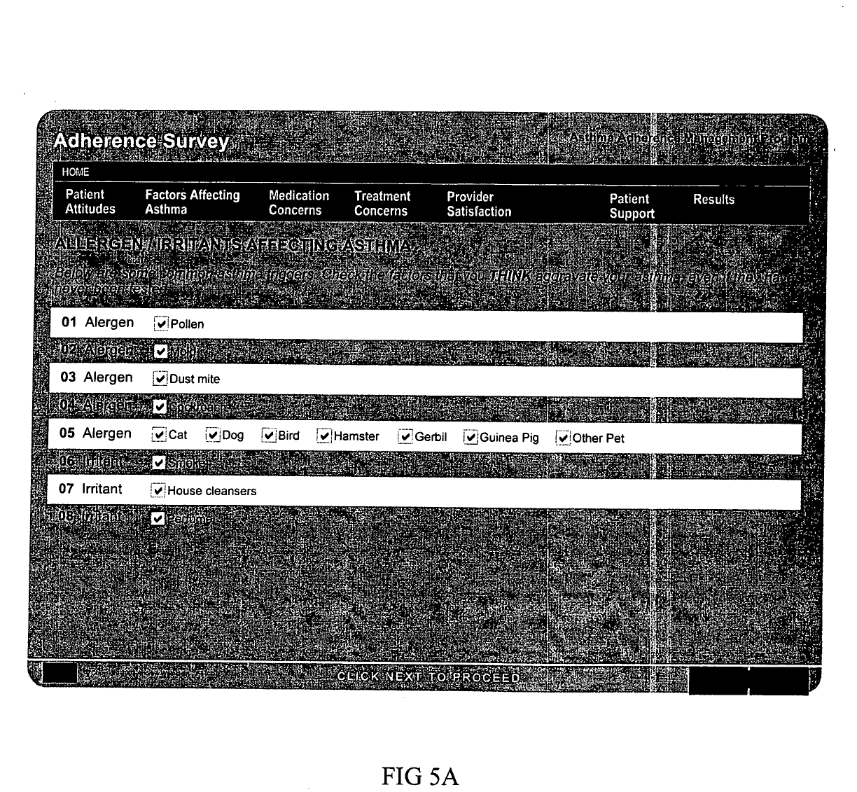

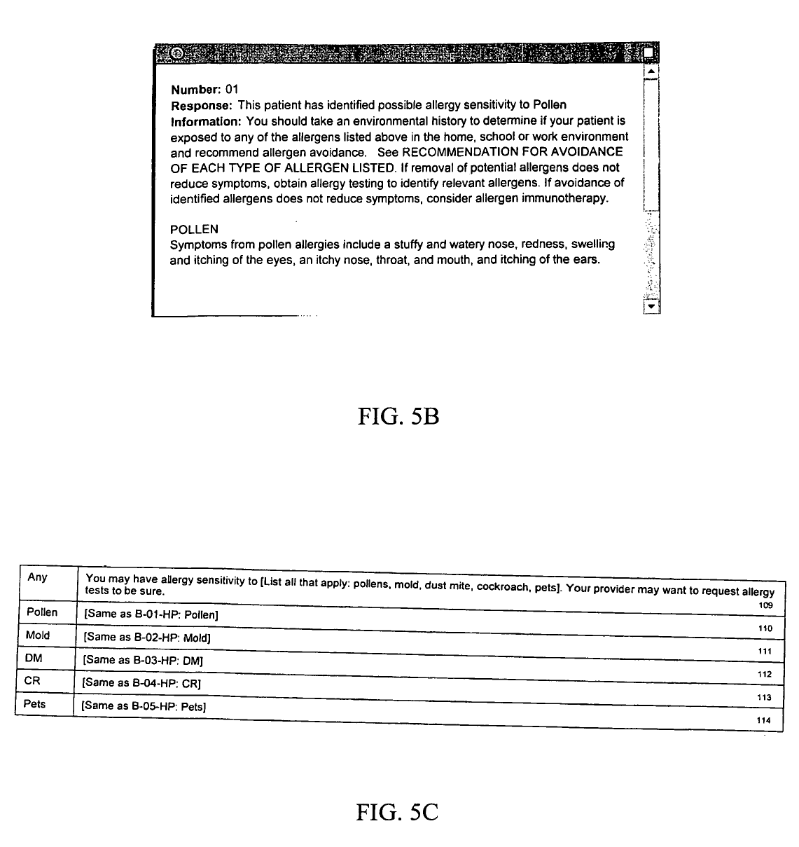

A non-limiting example of typical questions for an asthma patient are shown in FIG. 5A and FIG. 5B. FIG. 5A shows an exemplary set of survey responses regarding allergen/irritants affecting the chronic disease being treated. FIG. 5B shows an exemplary set of instructions for a healthcare provider based on the survey responses regarding allergen/irritants affecting the chronic disease being treated. FIG. 5C shows an exemplary set of instructions for a patient based on the survey responses regarding allergen/irritants affecting the chronic disease being treated. The questions shown in FIG. 5A would probe the patient's contact with known asthma initiators such as animals, dust mites, pollen, tobacco, smoke, etc.

For example, if the patient's survey responses express a reaction to airborne irritants or allergens, the use of a HEPA filter by the patient would be suggested to the healthcare provider by the instructions. In addition, if an ancillary medical condition is identified by the questions to the patient as a possible contributor to their chronic illness, the healthcare provider is also given instructions on how to treat the ancillary medical condition. Conversely, if certain medications used to treat the ancillary condition identified by the patient can adversely affect the chronic condition, the instructions would alert the healthcare provider of alternative medications that are less likely to adversely affect the chronic condition.

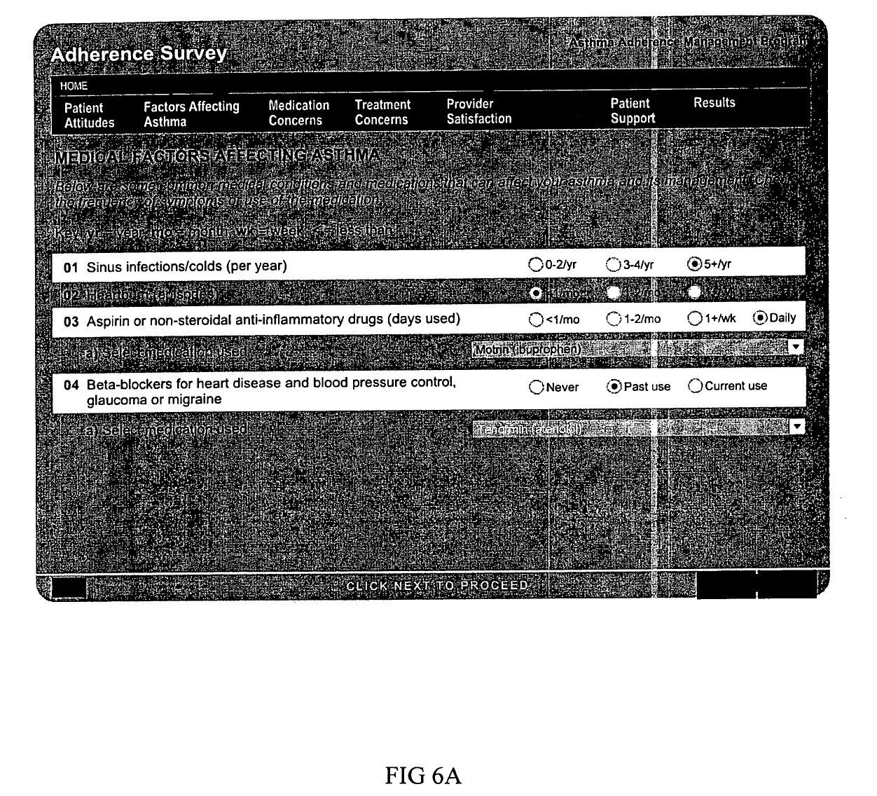

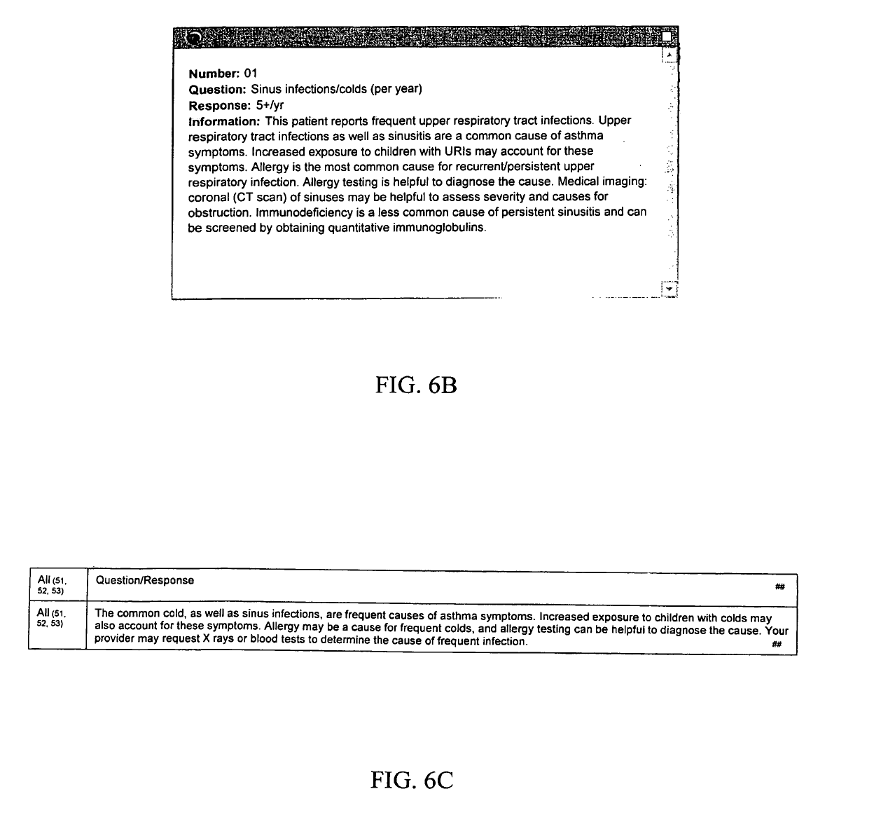

FIG. 6A shows an exemplary set of survey responses regarding medical factors affecting the chronic disease being treated. FIG. 6B shows an exemplary set of instructions for a healthcare provider based on the survey responses regarding medical factors affecting the chronic disease being treated. FIG. 6C shows an exemplary set of instructions for a patient based on the survey responses regarding medical factors affecting the chronic disease being treated.

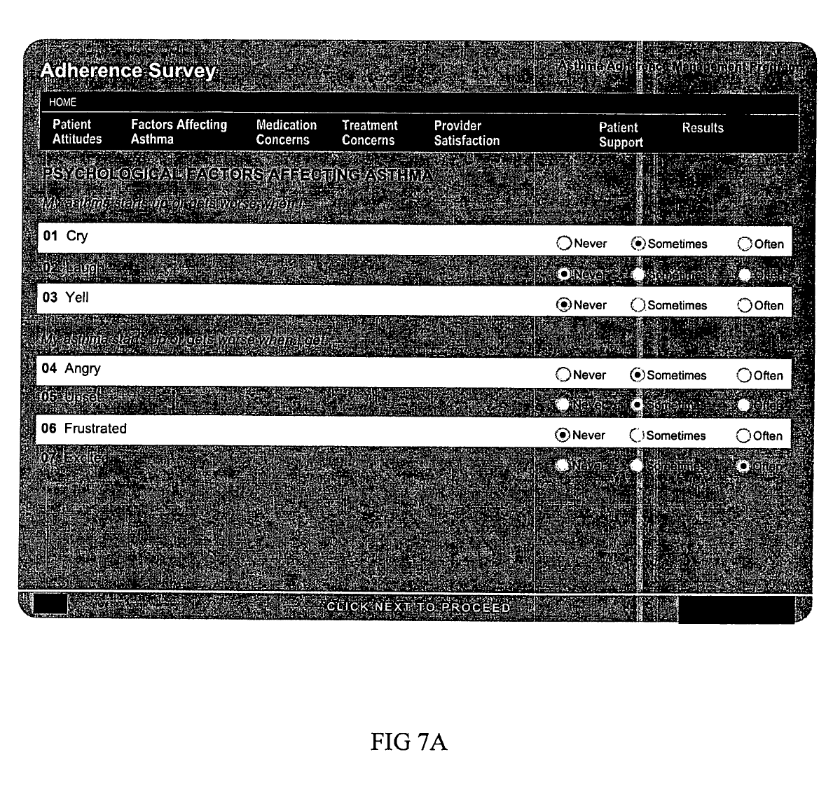

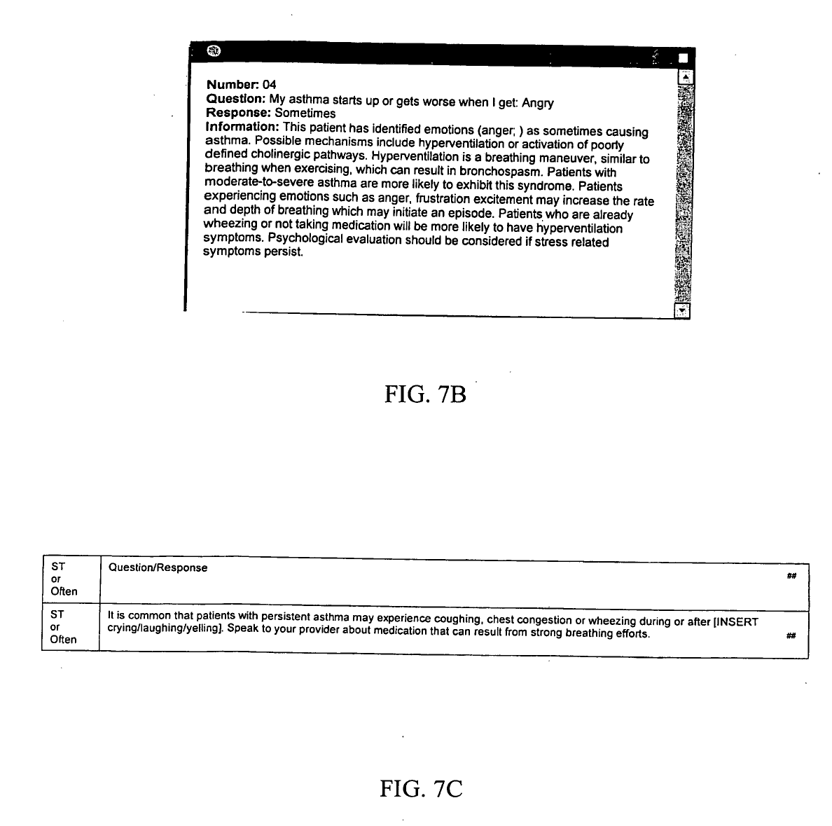

In addition, survey responses could also be directed at the patient's recognition of other causative factors such as medications and other medical ailments. These types of survey responses could have the dual benefit of: (1) alerting the patient to such factors so that they can be minimized and (2) providing a better database of information to assist the healthcare provider in reaching a knowledgeable diagnosis. FIG. 7A shows an exemplary set of survey responses regarding psychological factors affecting the chronic disease being treated. FIG. 7B shows an exemplary set of instructions for a healthcare provider based on the survey responses regarding psychological factors affecting the chronic disease being treated. FIG. 7C shows an exemplary set of instructions for a patient based on the survey responses regarding psychological factors affecting the chronic disease being treated.

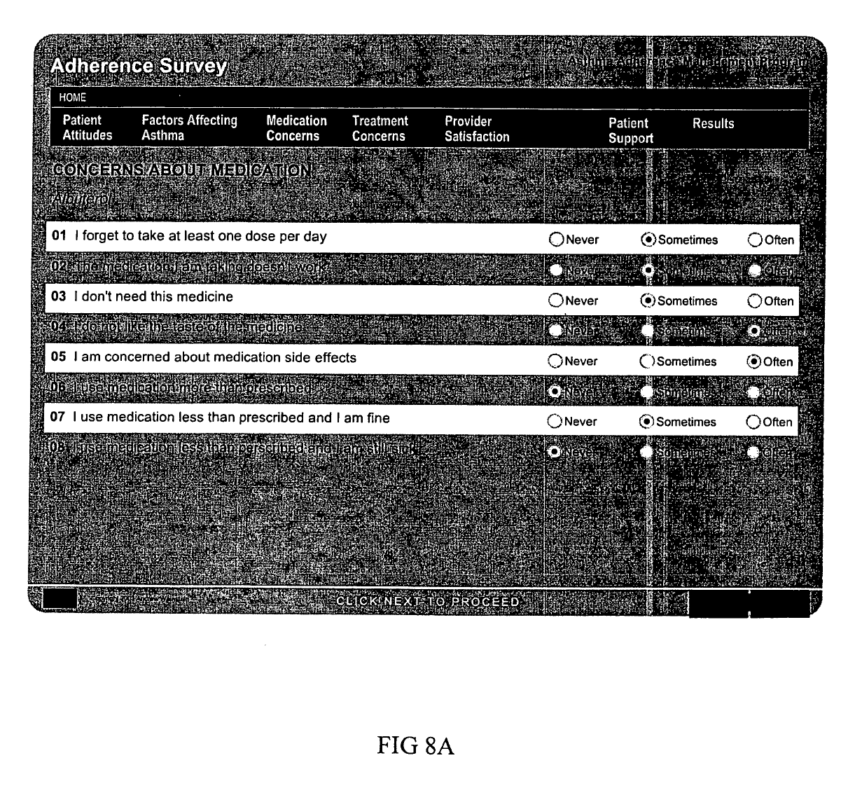

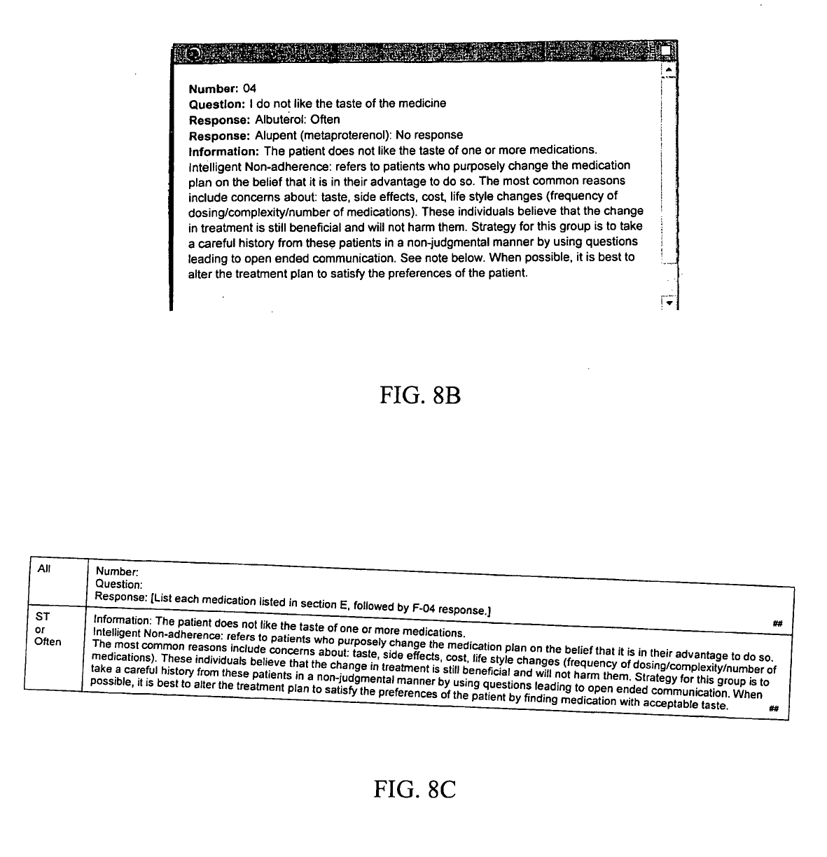

Another factor in patient adherence is the patient's own concerns about medication prescribed for treatment of a chronic disease. FIG. 8A shows an exemplary set of survey responses regarding a patient's concerns about medication that is part of a treatment regimen for the chronic disease. FIG. 8B shows an exemplary set of instructions for a healthcare provider based on the survey responses regarding a patient's concerns about medication that is part of a treatment regimen for the chronic disease. FIG. 8C shows an exemplary set of instructions for a patient based on the survey responses regarding a patient's concerns about medication that is part of a treatment regimen for the chronic disease.

Suggested questions about such concerns would include those directed to probing the patient's concerns about:
a) effectiveness of the medications;
b) taste of the medications;
c) reactions/side effects to the medication;
d) reasons for non-adherence with a medication treatment regimen (e.g., self regulated administration); and
e) cost of the medications.

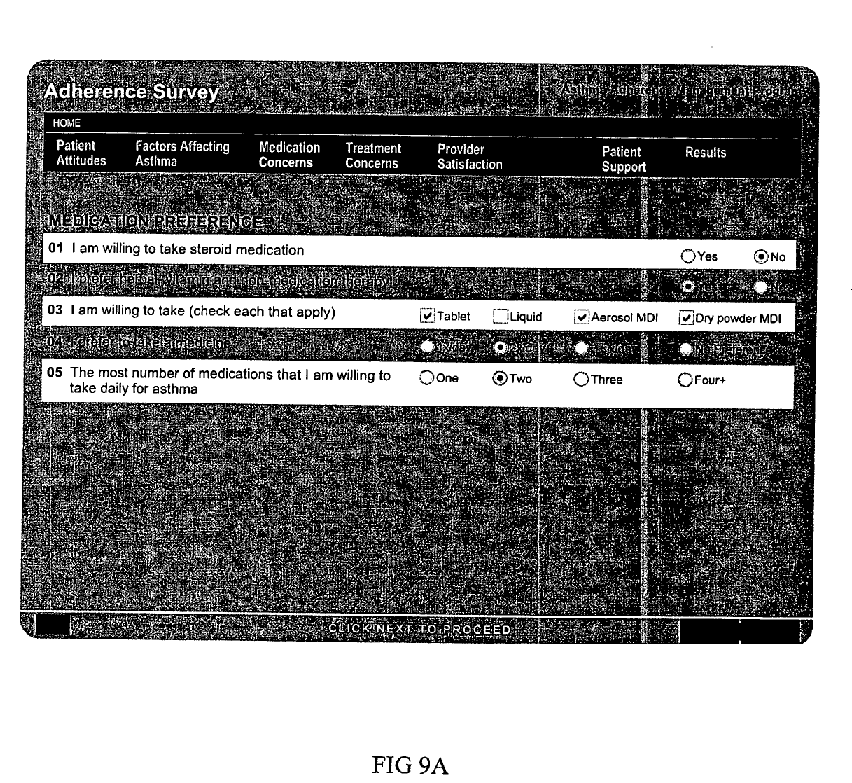

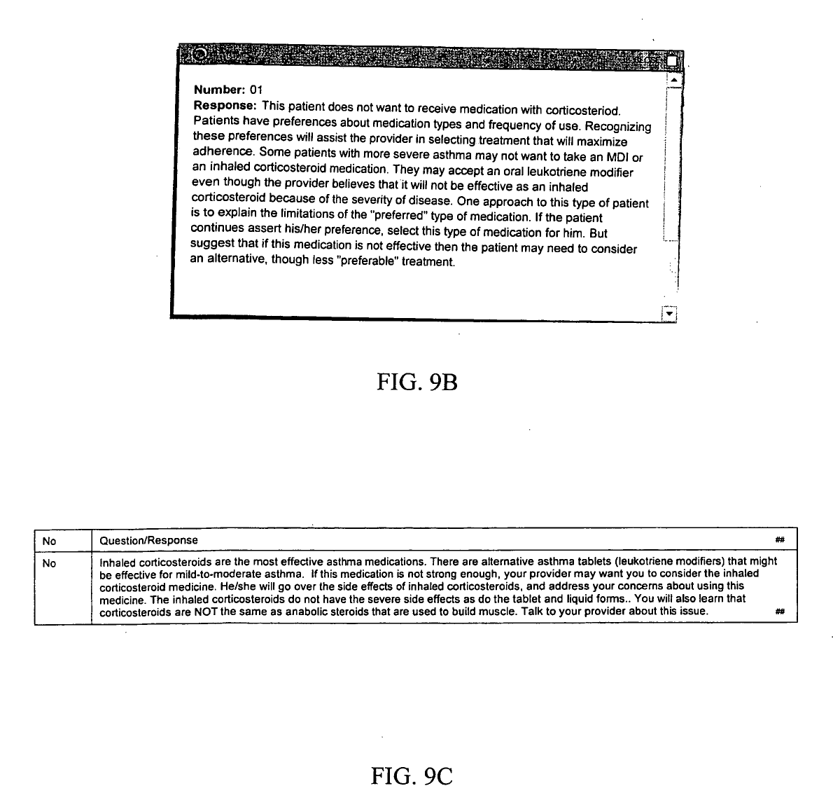

Yet another factor in patient adherence is the patient's opinions on and comprehension of the proper use of the medications that are a part of their treatment regimen. FIG. 9A shows an exemplary set of survey responses regarding a patient's medication preferences with respect to a treatment regimen for the chronic disease. FIG. 9B shows an exemplary set of instructions for a healthcare provider based on the survey responses regarding a patient's medication preferences with respect to a treatment regimen for the chronic disease. FIG. 9C shows an exemplary set of instructions for a patient based on the survey responses regarding a patient's medication preferences with respect to a treatment regimen for the chronic disease.

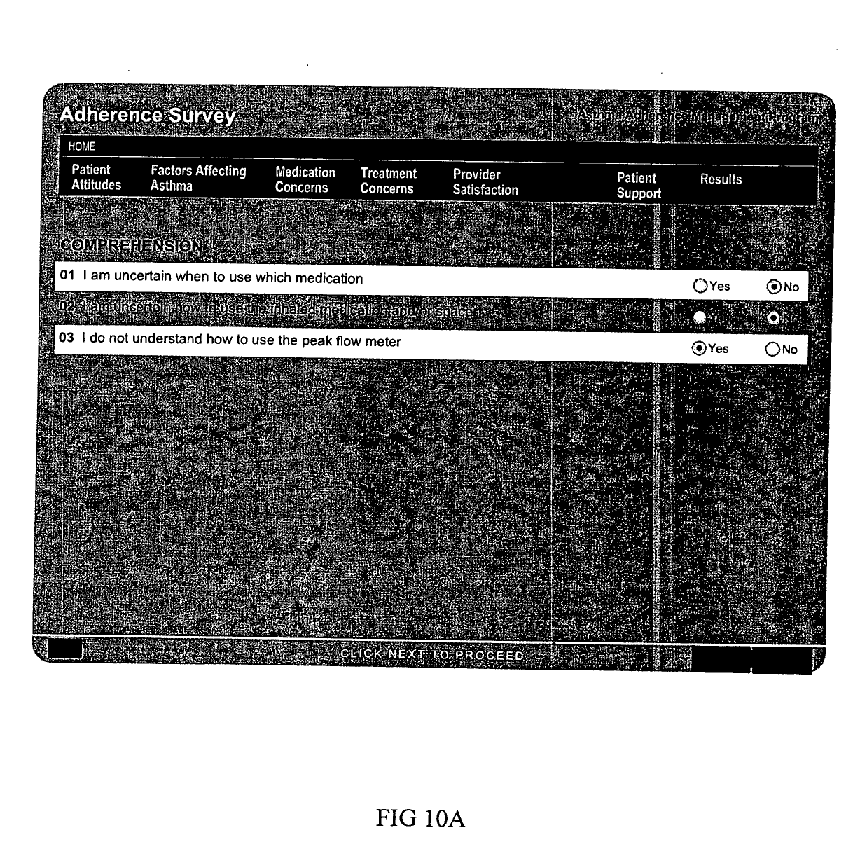

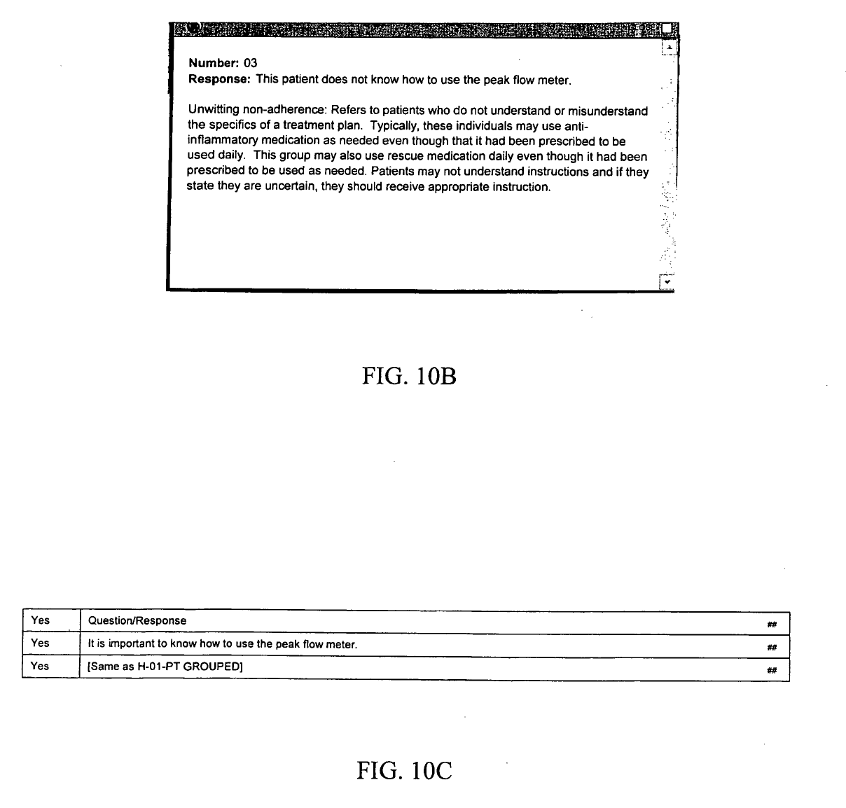

FIG. 10A shows an exemplary set of survey responses regarding a patient's comprehension/understanding of medications/equipment that is a part of a treatment regimen for the chronic disease. FIG. 10B shows an exemplary set of instructions for a healthcare provider based on the survey responses regarding a patient's comprehension/understanding of medications/equipment that is a part of a treatment regimen for the chronic disease. FIG. 10C shows an exemplary set of instructions for a patient based on the survey responses regarding a patient's comprehension/understanding of medications/equipment that is a part of a treatment regimen for the chronic disease.

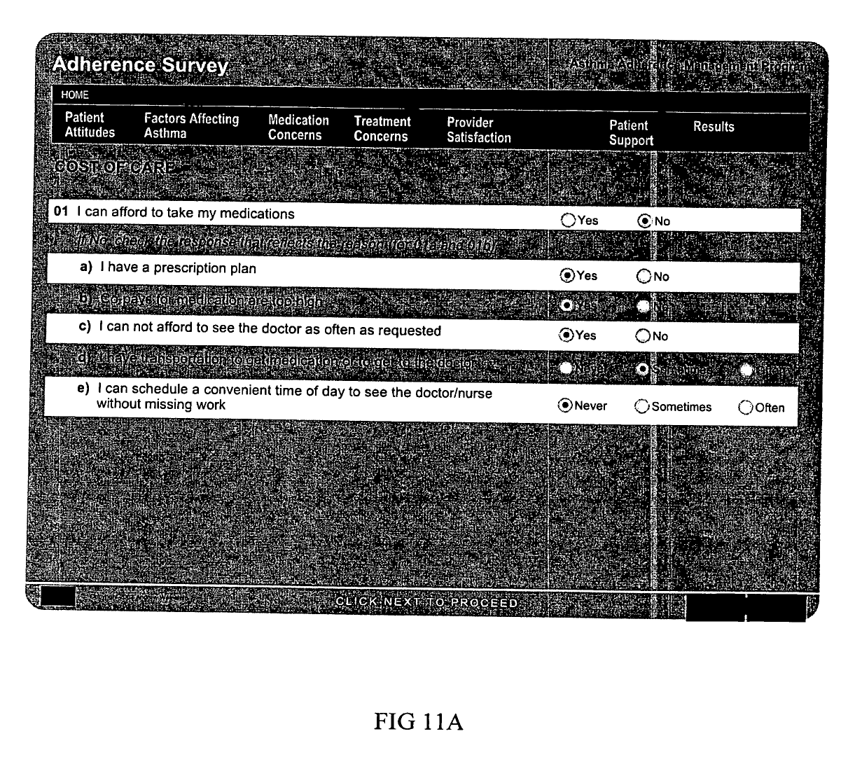

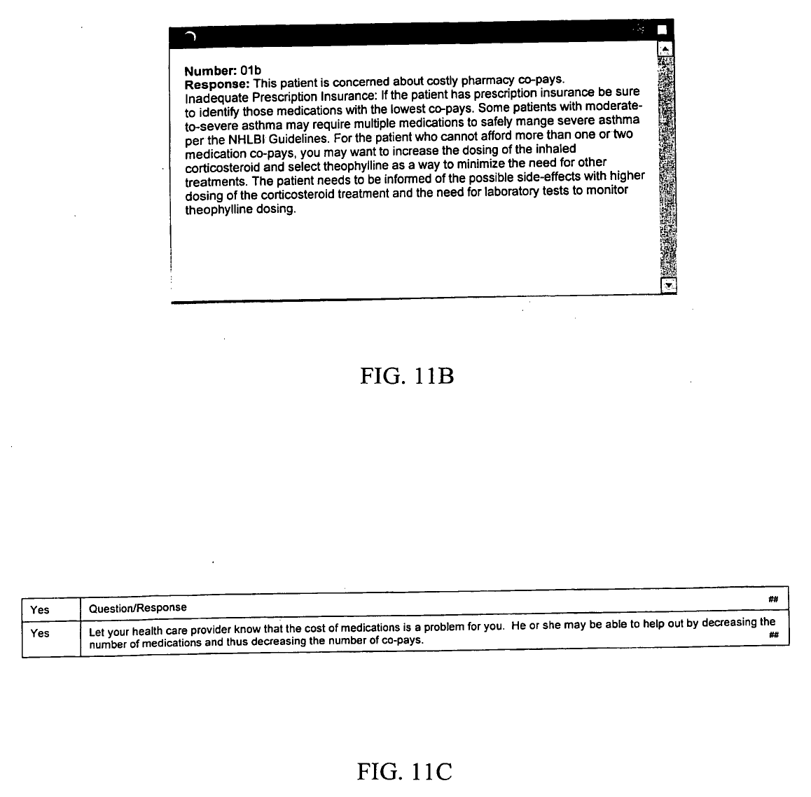

FIG. 11A shows an exemplary set of survey responses regarding cost of care for a treatment regimen for the chronic disease. FIG. 11B shows an exemplary set of instructions for a healthcare provider based on the survey responses regarding cost of care for a treatment regimen for the chronic disease. Where cost is cited by the patient as a reason for non-adherence, instructions to the healthcare provider include, but are not limited to referral to, a free clinic, consideration of Medicaid or SSI. FIG. 11C shows an exemplary set of instructions for a patient based on the survey responses regarding cost of care for a treatment regimen for the chronic disease.

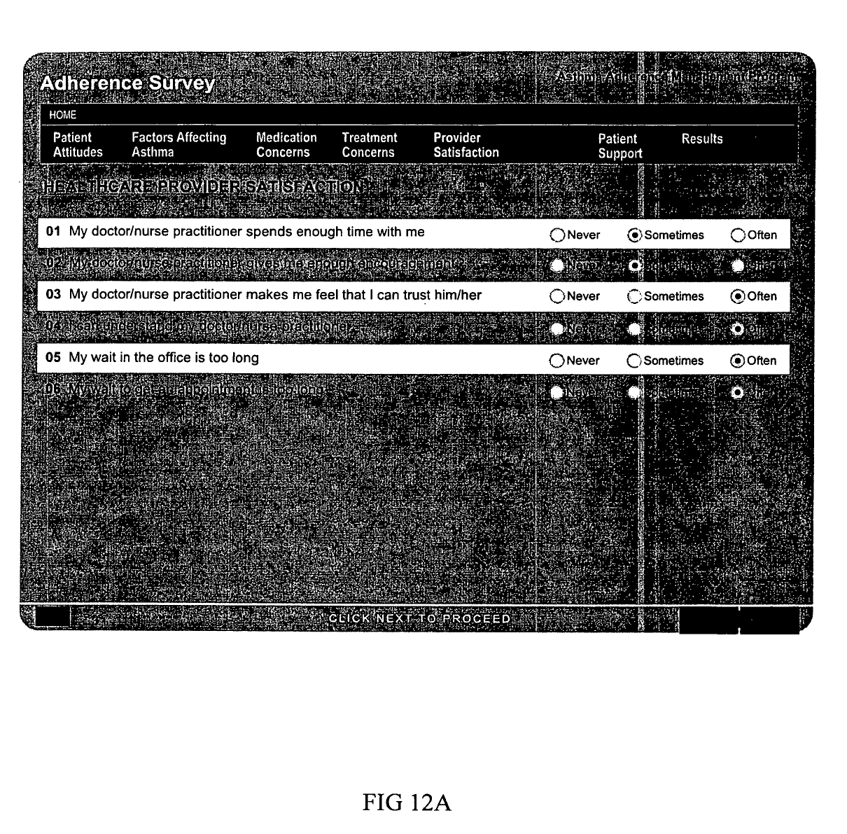

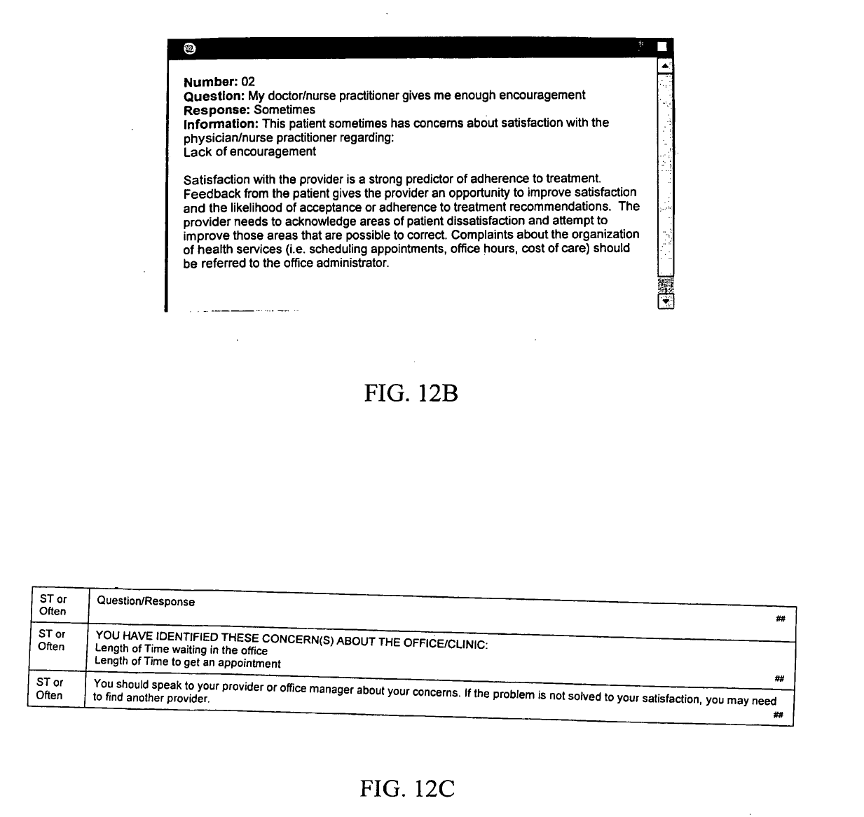

Yet again another factor in the patient adherence is directed to the patient's relationship with, and confidence in, the healthcare provider. FIG. 12A shows an exemplary let of survey responses regarding patient's satisfaction with healthcare providers. As shown in the non-limiting example of FIG. 12A, a set of questions to the patient could seek his/her assessment of the patience, communication skills and empathy of the healthcare provider, as well as environmental matters such as office conditions and time spent waiting for the healthcare provider.

FIG. 12B shows an exemplary set of instructions for a healthcare provider based on the survey responses regarding patient satisfaction with healthcare providers. As shown in the non-limiting example of FIG. 12B, instructions for the healthcare provider would emphasize the importance of patient satisfaction to patient treatment adherence. Moreover, the instructions for the healthcare provider could encourage the healthcare provider to modify practices found unacceptable to the patient, which should improve patient adherence with the treatment regimen. FIG. 12C shows an exemplary set of instructions for a patient based on the survey responses regarding patient satisfaction with healthcare providers.

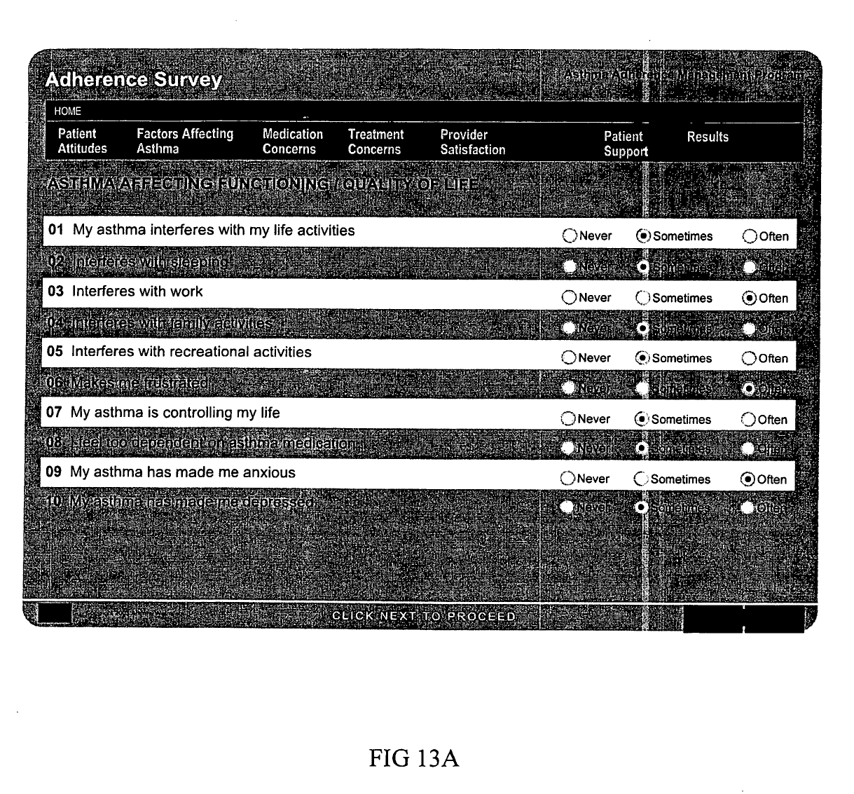

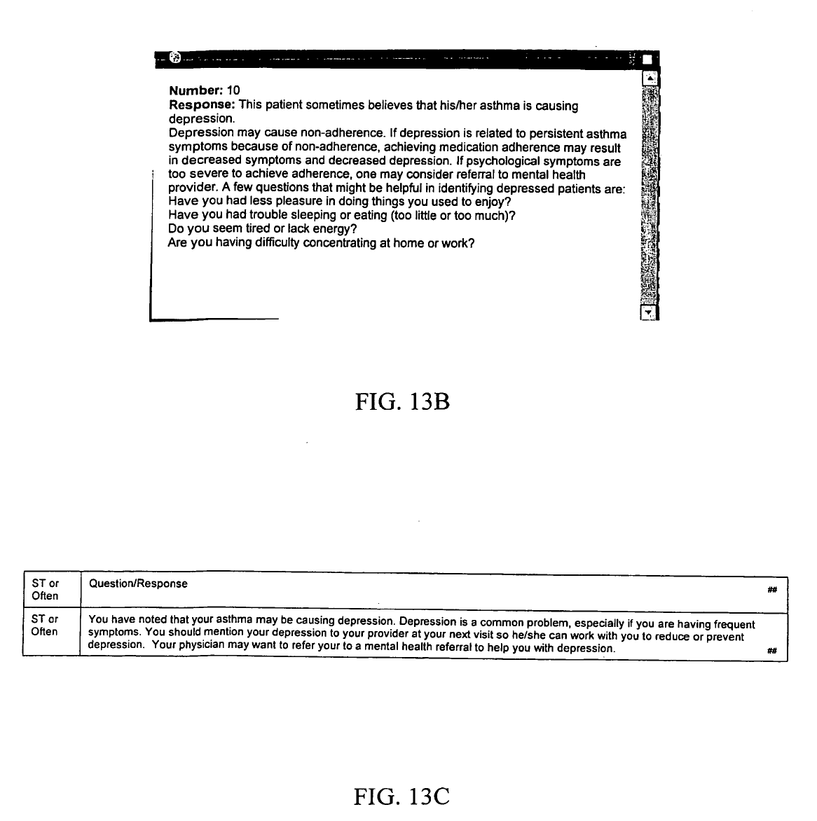

Yet another factor in patient adherence is analyzed by asking questions that probe the patient's quality of life. FIG. 13A shows an exemplary set of survey responses regarding patient's quality of life. These questions seek to elicit the patient's beliefs as to how the chronic disease affects his/her life. The questions posed ask about the impact of the disease on everyday activities ranging from sleeping to exercise. As shown in the non-limiting example of FIG. 13A, the questions also seek to elicit the toll of the chronic disease on patient's emotional well being (e.g., whether the patient is depressed or anxious).

FIG. 13B shows an exemplary set of instructions for a healthcare provider based on the survey responses regarding patient's quality of life. As shown FIG. 13B, the instructions for the healthcare provider alert the healthcare provider to the medical toll that depression, anxiety and like factors can have on the patient's adherence to the treatment regimen. The instructions to the healthcare provider emphasize the importance of alerting patients to the need for treatment adherence in order to improve the patient's quality of life. FIG. 13C shows an exemplary set of instructions for a patient based on the survey responses regarding patient's quality of life.

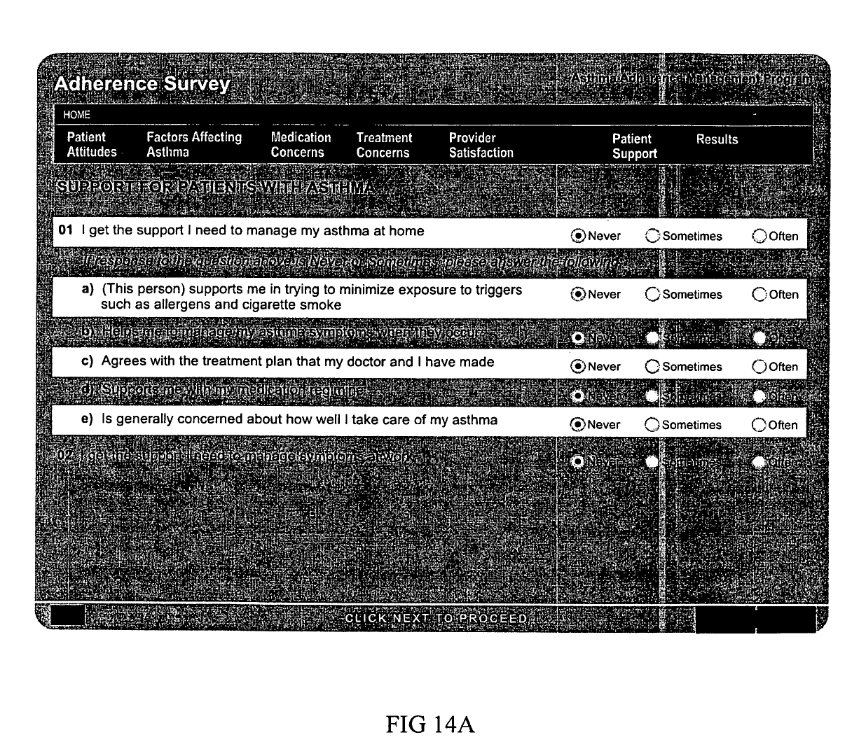

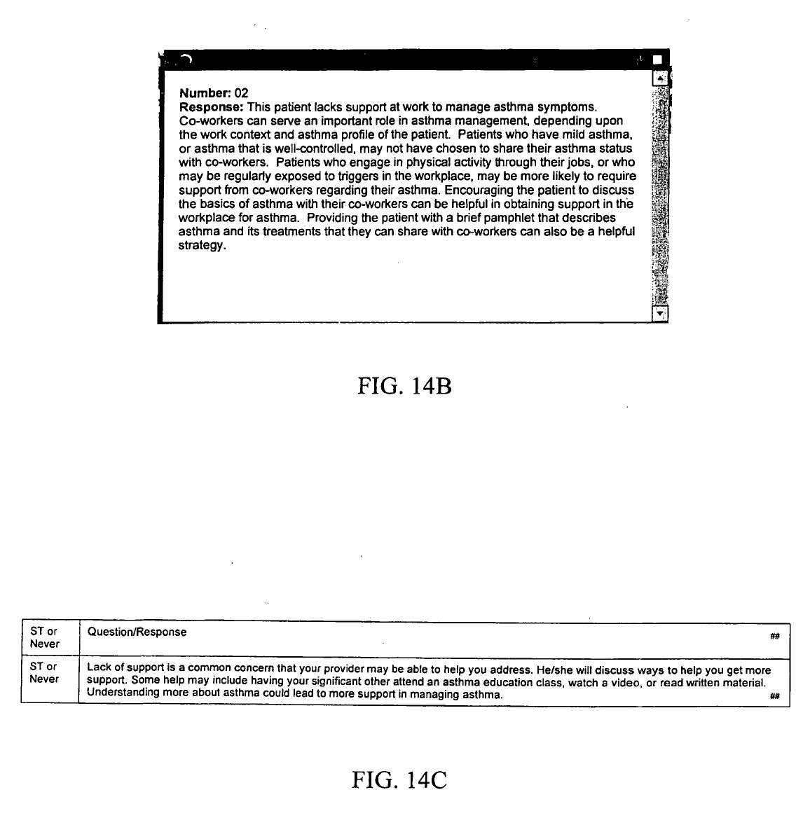

Yet again another factor in patient adherence is the questioning of patient in order to probe the support received by the patient within their family and at work. FIG. 14A shows an exemplary set of survey responses regarding support for a patient with a chronic disease. FIG. 14B shows an exemplary set of instructions for a healthcare provider based on the survey responses regarding support for a patient with a chronic disease. The resulting instructions for the healthcare provider may include but are not limited to arrangements for family counseling to raise the family's awareness of the patient's treatment needs. The instructions for the healthcare provider also include the use of pamphlets that can be given out at work to inform co-workers of the chronic condition being treated. FIG. 14C shows an exemplary set of instructions for a patient based on the survey responses regarding support for a patient with a chronic disease.

The foregoing description illustrates and describes the present invention. Additionally, the disclosure shows and describes only the preferred embodiments of the invention, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments. Moreover, it is to be understood that other embodiments may be utilized and structural changes may be made without departing from the scope of the present invention.

1. A method for promoting and improving patient adherence to a treatment regimen for a chronic disease comprising:
surveying a patient with questions based on a group of factors related to the treatment of the chronic disease;
analyzing the patient's survey responses to said questions;
selecting instructions for healthcare providers based on analyzing the patient's survey responses;
selecting instructions for the patient based on analyzing the patient's survey responses;
communicating the patient's survey responses and instructions for healthcare providers to the healthcare providers;
communicating instructions for the patient to the patient; and
prescribing a new treatment regimen to improve the patient's adherence based on the patient's survey responses and instructions communicated to the healthcare providers and the patient.

2. The method of claim 1, wherein said group of factors further comprises at least one of the patient's attitude toward the condition being treated, the patient's understanding of the treatment regimen prescribed, the patient's self-assessment of his/her adherence to the treatment regimen, the patient's satisfaction with the healthcare provider, the patient's understanding of factors affecting the chronic disease being treated; and the patient's concerns about the treatment regimen.

3. The method of claim 2, wherein said patient's concerns include at least one of cost, side effects and the patient's support structure.

4. The method of claim 1, wherein said analyzing is performed by at least one of a computer system local to the patient and a computer system local to the healthcare provider.

5. The method of claim 1, wherein said selecting instructions for healthcare providers is performed by at least one of a computer system local to the patient and a computer system local to the healthcare provider.

6. The method of claim 1, wherein said selecting instructions for the patient is performed by at least one of a computer system local to the patient and a computer system local to the healthcare provider.

7. The method of claim 1, wherein said communicating the patient's responses and instructions is provided by at least one of direct communications, wireless communications, local area networks and Internet.

8. The method of claim 1, wherein said communicating instructions for the patient is provided by at least one of direct communications, wireless communications, local area networks and Internet.

9. The method of claim 6, wherein direct communications includes at least one of oral, written and wired telephone communications.

10. The method of claim 6, wherein wireless communications includes at least one of radio and cellular telephone.

11. The method of claim 8, wherein direct communications includes at least one of oral, written and wired telephone communications.

12. The method of claim 8, wherein wireless communications includes at least one of radio and cellular telephone.

13. An apparatus for promoting and improving patient adherence to a treatment regimen for a chronic disease comprising:
means for surveying the patient with questions based on a group of factors related to the treatment of the chronic disease;
means for analyzing the patient's survey responses to said questions;
means for selecting instructions for healthcare providers based on analyzing the patient's survey responses;
means for selecting instructions for the patient based on analyzing the patient's survey responses;
means for communicating the patient's responses and instructions for healthcare providers to the healthcare providers;
means for communicating the instructions for the patient to the patient; and
means for prescribing a new treatment regimen to improve the patient's adherence based on the patient's survey responses and instructions communicated to the healthcare providers,
wherein the means for surveying and the means for analyzing are connected by the means for communicating.

14. The apparatus of claim 13, wherein said group of factors comprise at least one of the patient's attitude toward the condition being treated, the patient's understanding of the treatment regimen prescribed, the patient's self-assessment of his/her adherence to the treatment regimen, the patient's satisfaction with the healthcare provider, the patient's understanding of factors affecting the chronic disease being treated; and the patient's concerns about the treatment regimen.

15. The apparatus of claim 13, wherein said means for analyzing includes at least one of a computer and communication system local to the patient and a computer and communication system local to the healthcare provider.

16. The apparatus of claim 13, wherein said means for selecting is performed by at least one of a computer system local to the patient and a computer system local to the healthcare provider.

17. The apparatus of claim 13, wherein said means for communicating is provided by at least one of direct communications, wireless communications, local area networks and Internet.

18. The apparatus of claim 14, wherein said concerns include at least one of cost, side effects and the patient's support structure.

19. The apparatus of claim 15, wherein the means for analyzing further comprises a microprocessor, memory, input devices and output devices.

20. The apparatus of claim 19, wherein the memory is at least one of a diskette, compact flash and portable media.

21. The apparatus of claim 19, wherein the input devices are at least one of a touch panel screen display, keyboard, mouse and microphone.

22. The apparatus of claim 19, wherein the output devices are at least one of a graphics display monitor and speaker.
